(19) United States
(12) Patent Application Publication
(10) Pub. No.: US 2020/0240335 A1
(43) Pub. Date: Jul. 30, 2020

(54) PREMIER EFFICIENCY HYBRID FUELS SYSTEMS METHODS AND DEVICES COMPRISING DIESEL AND PROPANE INTER ALIA

(71) Applicant: Irwin Menken, New York, NY (US)

(72) Inventor: Irwin Menken, New York, NY (US)

(21) Appl. No.: 16/773,894

(22) Filed: Jan. 27, 2020

Related U.S. Application Data
(60) Provisional application No. 62/797,457, filed on Jan. 28, 2019.

(51) Int. Cl. F02D 41/00; G06N 20/00; F02M 21/02; F02D 19/08

(52) U.S. Cl. CPC F02D 41/0027; G06N 20/00; F02D 19/08; F02M 21/0221; F02M 21/0227; F02M 21/0212

(57) ABSTRACT

Hardware and software provide a system for propane injection modified in real-time by an AI engine driving fuel efficiency, whereby data for more than one vehicle within a truck fleet is agglomerated and shared. According to this example, the cost of propane per gallon is generally ⅓ that of diesel, and our controller injects propane as an additive in far smaller amounts than diesel used, achieving a propane mpg of approximately 50-70 mpg. This means that a truck carrying 50 gallons of propane can get at least about 2200-3800 miles between refueling stops, in this example.

### CROSS-REFERENCE TO PRIORITY CLAIM

U.S. Provisional patent application number 62/797,457 filed Jan. 28, 2019, and all data and patents and patent applications referenced therein are expressly incorporated by reference herein.

### FIELD OF THE DISCLOSURE

The present disclosures relate to the optimization of internal combustion engine fuel blends and mixtures and machine learning to perfect data sets regarding the same, implemented for example in fleets of trucks. In specific, the instant disclosures are blue technology, or comprise issue essential to power the needs of the modern world.

### BACKGROUND OF THE DISCLOSURE

Years of trying to combine multiple fuels have yet to yield a utile solution, until the advent of the present inventions. Incorporated by reference, as if expressly set forth herein, are the listed United States Letters Patent in this document, each of which is different from the present inventions, yet serves to define the State of the Art of the

Also, by leveraging the infrastructure built by the new propane truck manufacturers for fueling and maintenance on the road as well as joining in on TV infrastructure arrangements progress in science and the useful arts is proposed.

Additionally, the technology is adaptable to other diesel engine applications including maritime, construction equipment, agricultural engines and generators.

All of these will in fact be simpler to implement due to fewer variables which include load, vibration, terrain, portability and regulation.

Additionally, according to the there is an opportunity for entry into, or enhancing a current propane business through additional propane gas and equipment sales.

Using the species of example of the trucking industry, there are approximately 15,000,000 diesel delivery trucks ranging in size from local/medium distance box trucks to Class 8 long haul heavy diesel (18 wheel tractor/trailers), of these at least about 3,000,000 are Class 8 trucks (tractor/trailers) which represent a species of the invented genus.

### OBJECTS AND SUMMARY OF THE INVENTION

Briefly stated, hardware and software provide a system for propane injection modified in real-time by an AI engine driving fuel efficiency, whereby data for more than one vehicle within a truck fleet is agglomerated and shared to the digital benefit of all. As the cost of propane per gallon is generally ⅓ that of diesel, and our controller injects propane as an additive in far smaller amounts than diesel used, achieving a propane mpg of approximately 50-70 mpg. This means that a truck carrying 50 gallons of propane can get at least about 2200-3800 miles between refueling stops, in this example.

According to features of the present invention are disclosed, all features shown and claimed, when combined with prior art teachings are new, novel and non-obvious, it is respectfully proposed, because they are unexpectedly better than predicted by science.

According to embodiments there are disclosed, paradigms for retrofitting diesel systems to manage conversion to more efficient systems, comprising, in combination; providing a set of engines to be re-configured; addressing the inflow of propane, via data gathered from individuated smart units; gating the engine management system communications network with a centralized Artificial Intelligence Data structure set, said AI Data structure set further comprises, at least a central controller filtering a set of HUB for Data inputs; likewise, aggregated from sub-data aggregation units, and recombined for efficiency driven propane flow scenarios, particulates, and other interim data sets, whereby said machine learning actuates the paradigm's propane gate.

### BRIEF DESCRIPTION OF THE DRAWINGS

Various preferred embodiments are described herein with references to the drawings in which merely illustrative views are offered for consideration, whereby:

FIG.1 is a table showing data comprising proprietary data sets for an example of the present invention illustrated herein;

FIG. 2 is a table showing data comprising proprietary data sets for an example of the present invention illustrated herein;

FIG. 3 is a table showing data comprising proprietary data sets for an example of the present invention illustrated herein;

FIG. 4 is a table showing data comprising proprietary data sets for an example of the present invention illustrated herein;

FIG. 5 is a table showing data comprising proprietary data sets for an example of the present invention illustrated herein including 30 mile course runs Eastbound and Westbound over the same road;

FIG. 6 is a schematic data management scheme implemented according to the instant teachings; and,

FIG. 7 illustrates the instant design process according to the present invention.

Corresponding reference characters indicate corresponding components throughout the several views of the drawings. Skilled artisans will appreciate that elements in the Figures are illustrated for simplicity and clarity, and have not necessarily been drawn to scale. For example, the dimensions of some of the elements in the Figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTIONS

The present inventor has embraced the challenge of increasing the ability to use hydrocarbon-based fuel systems as we transition toward future sustainability goals, mindful that existing infrastructure and resources need to be accounted for in any proposed solutions. In so doing, using an array of data including emissions measurements on all involved engines, provides the best path to improvements.

By way of example, according to the provisional patent application in which the instant systems were disclosed, the concept of being ideally positioned to retrofit the 15,000,000 diesel powered Class 8 and medium sized trucks that are on the road constitutes a proof of feasibility and concept according to data proffered in support of the instant teachings. The present invention also fits the newest diesel vehicles still being sold and delivered currently and into the future.

It is respectfully proposed that the instant inventions are ideally positioned to retrofit at least about 15,000,000 diesel powered Class 8 and medium sized trucks that are on the road, along with fitting the newest diesel vehicles still being sold and delivered currently and into the future because it has reviewed the assumption that, for example numerous trucking fleets (inter alia) cannot be converted to zero emissions instantaneously, but must be gradually transitioned over time.

It is likewise respectfully submitted that by leveraging the infrastructure built by the new propane truck manufacturers for fueling and maintenance on the road as well as joining in on JV infrastructure arrangements, that the present inventions can become an accepted standard for this class of vehicle and tasks.

The present inventor has discovered how to blend, flow-monitor and optimize hybrid fuels in ways universally accessible to work engines, systems and fleets.

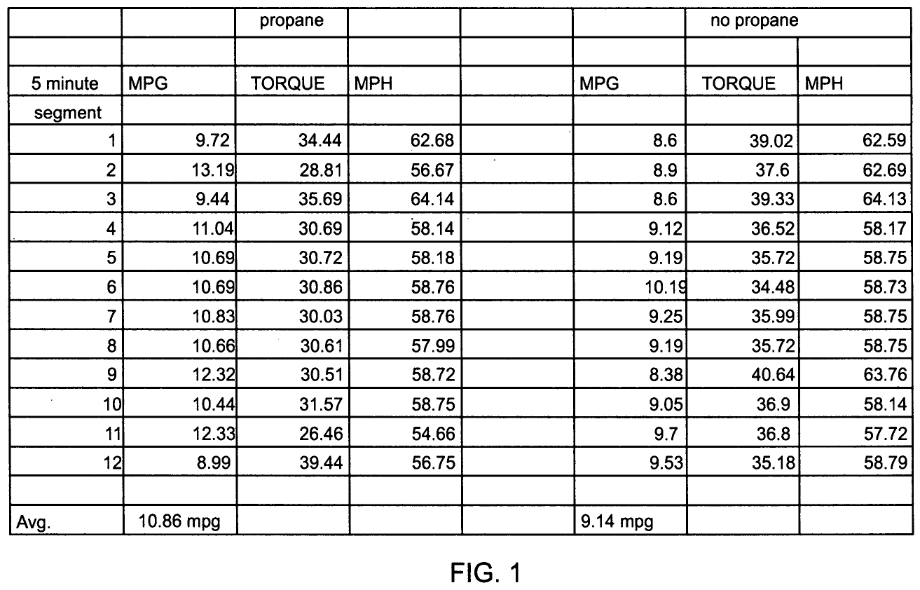

Referring now to the Figures, FIG. 1 is a table showing data comprising proprietary data sets for an example of the present invention illustrated herein, as fully set forth in the provisional from which priority is claimed, namely U.S. Provisional patent application No. 62/797,457 filed Jan. 28, 2019.

“Personal digital members” as used herein refers to units, boxes, chip-sets and the related hardware transducing the instant data into operational instructions for blending propane, for example, into diesel, with the example of trucks and trucking fleets, it is respectfully submitted.

The process of injecting propane into the airside of the diesel combustion mix has been around for 50+ years. The advantages of propane injection include fuel efficiency, emissions reduction (both particulates and greenhouse gases) and the generation of additional engine power.

The analog solutions that have been prevalent in the past do not allow for careful monitoring of propane flow and are limited to injecting propane at a fixed rate with a single engine parameter.

The digital systems that exist have yet to optimize propane flow to maximize the fuel's potential leading to inconsistent results.

Our digital solution allows for multiple data points and an infinite range of propane flow.

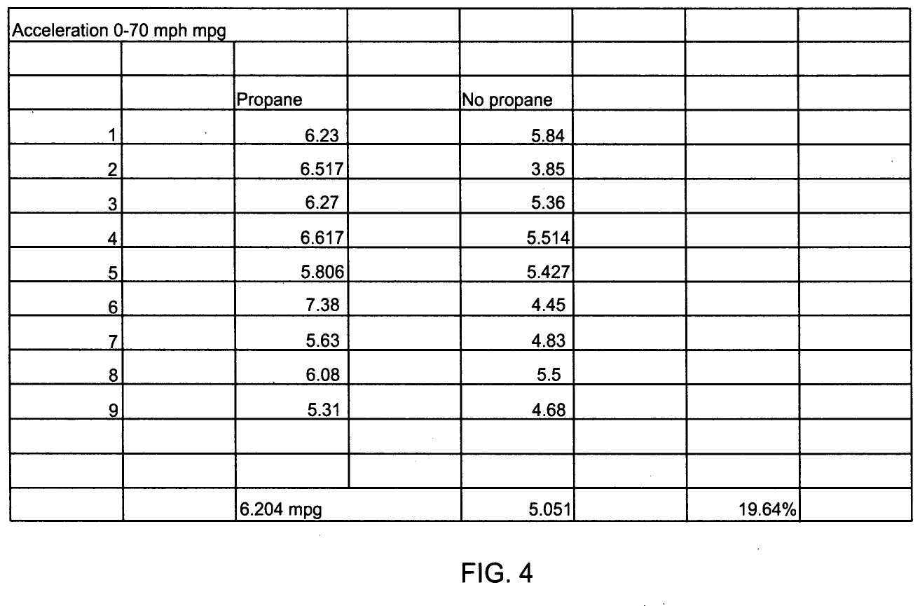

Referring now to the Tables in FIG. 1 through FIG. 5, data showing increased benefits of Propane blended with diesel is shown. In 1/6, FIG. 1 shows that low thresholding is present whereby 5 minute segments shown statistically significant benefits. Likewise, in 2/6 both MPH increases support of the instant systems.

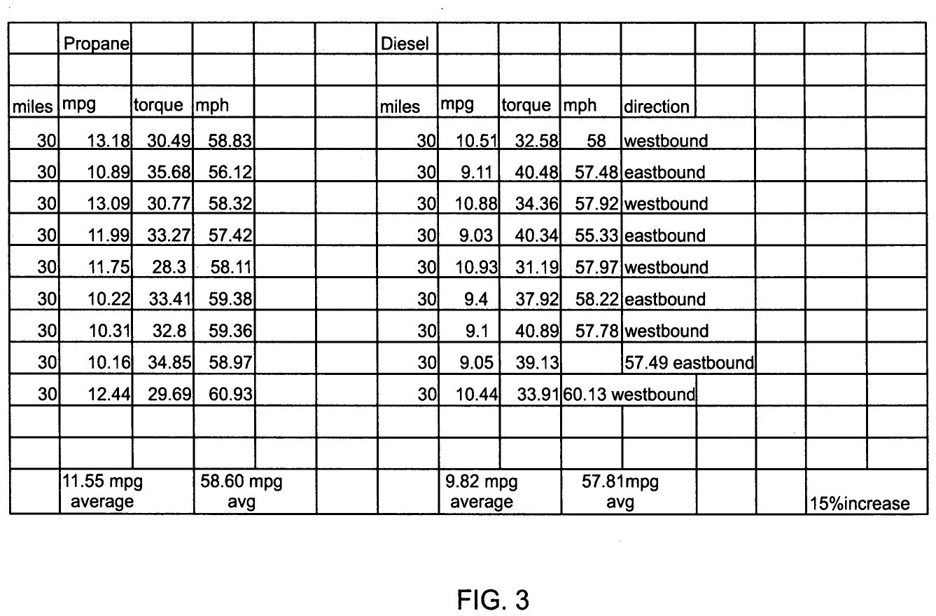

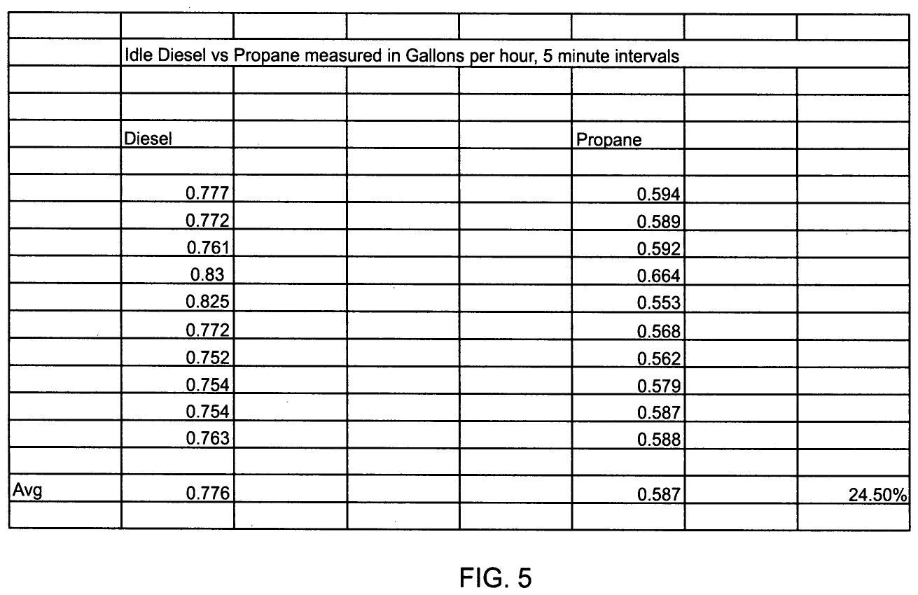

FIG. 3/6 through 5/6 demonstrate that with proper modulation, increase in efficiency abound with the instant system. Likewise, FIG. 5 is a table showing data comprising proprietary data sets for an example of the present invention illustrated herein including a 30-mile course runs Eastbound and Westbound over the same road.

Comprehensive testing on actual vehicles over several thousand miles across multiple propane flow scenarios have given us fuel efficiency savings at highway cruise speeds of 12-20% dependent on vehicle speed and weather/terrain conditions.

Further testing covering other driving modes including acceleration, emissions regeneration and in town driving are underway.

Additionally, the technology is adaptable to other diesel engine applications including construction equipment, agricultural engines and generators. All of these will in fact be simpler to implement due to fewer variables, which include load, vibration, terrain, portability and regulation.

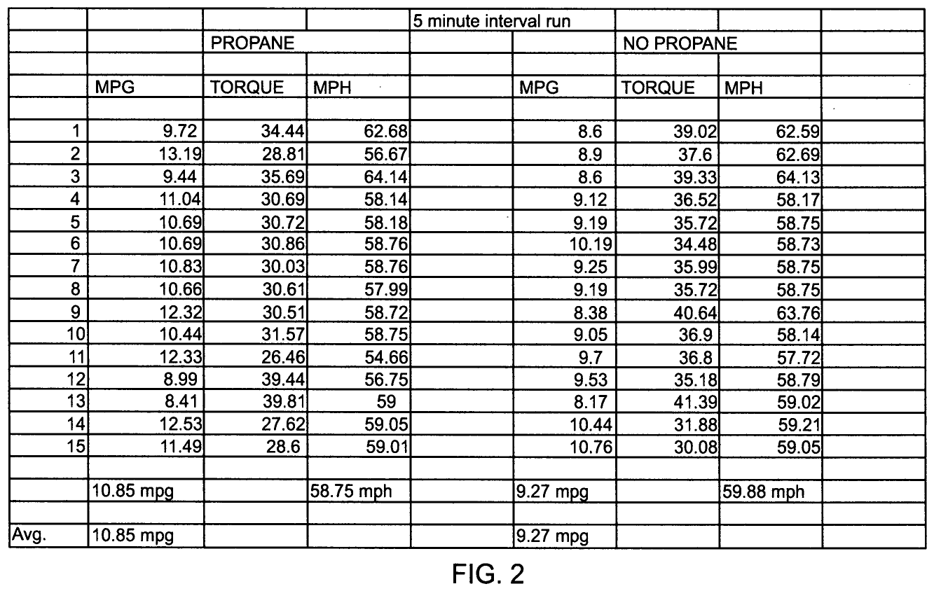

FIG. 2 through FIG. 4 show more of the data as discussed embodied in the instant system, as fully discussed described and shown in U.S. Provisional patent application No. 62/797,457 filed Jan. 28, 2019.

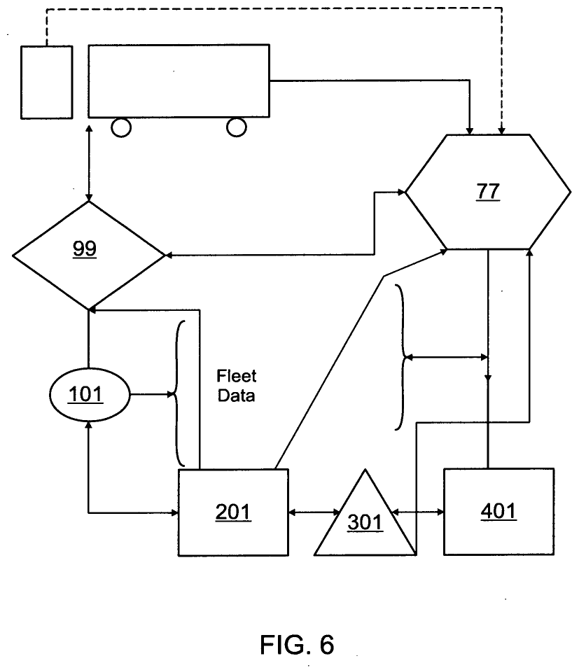

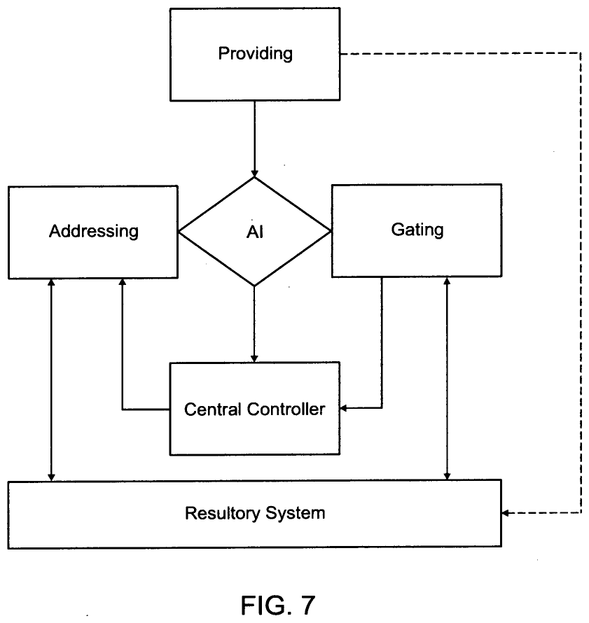

FIG. 6 and FIG. 7 both feature an inventive “Digital Controller/Central Controller” 77 defined as hardware with proprietary software embodied therein, for example an ARDUINO circuit board, using AI J1939 translators along with the functional capabilities described herein and within all documents incorporated by reference.

Digital Controller/Central Controller 77 further comprises a centrally located data hub which combined data streams and renders useful the ongoing efficiency emissions and related data to optimize the instant blends of propane and diesel.

Green Additive Technologies (Atlanta, Ga. USA) has developed proprietary software that receives data from engine management systems using the current J1939 communications protocol. This allows the present invention, for example to program digital controller/central controller to deliver propane through a vapor injector at precise rates and under specific engine parameters.

The digital controller drives the instant system and algorithms.

As the cost of propane per gallon is generally ⅓ that of diesel, and our controller injects propane as an additive in far smaller amounts than diesel used, our system will achieve a propane mpg of approximately 50-70 mpg. This means that a truck carrying 50 gallons of propane can get approximately 2000-3500 miles between refueling stops.

Additionally, trucks that return to the same location several times per week can operate with smaller tanks, reducing equipment costs and shortening ROI.

Turning now to FIG. 6, data flow is embodied in fleet data 101 being streamed and fed and replied to through central controller 201 which adjusts each sub-data aggregation units 301, 401 to the hub for data and the AI embodying the same. According to the instant system, the ostensive “black box” connected with dotted lines comprising either the cab or the unit within, for example, the cab or the truck transmits constant and/or data in pulsed waves to the system hub—here hub for data, throughout the balance of the AI ecosystem propagated according to the instant teachings.

Basis for developed software and applications embodying the same. This applies to all known propane systems but has been proven in trucks, which are a moderately complex example.

We have developed proprietary software that allows us to receive data from engine management systems. This allows us to program our controller to deliver propane through a vapor injector at precise rates and under particular engine conditions. Currently, we have proven successful parameters during engine cruise conditions (steady state driving at highway speeds) and hard acceleration (0-70 mph under load).

### EXAMPLE ONE

### Trucking Fleet

Along with regular testing in a controlled environment (i.e.: same vehicle, consistent driver, load conditions, terrain) we have optimized fleet testing using our initial parameters on trucks in the field.

Results to date show, referring to Table 1 to Table 5 in FIG. 1 to FIG. 5, that efficiency can be achieved using our box and data flow. Optimization of related parameters is achieved in the teachings of the present invention, as understood by those having a modicum of skill in the art. Namely, each Figure shows that the software driving the instant engine management system can achieve better efficiency than the known systems on the market and available, as currently configured and subject to Letters Patent of the United States.

Referring now once again to FIG. 7 and to FIG. 6, the instant systems comprises a process for retrofitting diesel systems to manage conversion to more efficient systems, comprising, in combination, the steps, in whichever order works best of, providing a set of systems to be re-configured in terms of efficiency and emissions;

addressing the inflow of propane, via data gathered from individuated units; gating the management system communications network with a centralized Artificial Intelligence Data structure set, said AI Data structure set further comprises:

At least a central controller filtering a set data points for hub for data inputs;

Aggregated from sub-data aggregation units, and recombined—for efficiency driven propane flow scenarios, particulates, and other interim data sets, whereby said machine learning actuates at least a portion of the paradigm's propane gate.

The present inventor has provided versions of the instant systems, useful for truck fleets, further comprising, in combination, a tank, being PPI 48 or 20 gallon aluminum certified for auto gas use with a cut-off solenoid, a UL approved line filter to eliminate air bubbles in line, a Beam Garrettson brand of vaporizing regulator which is auto gas approved, a HANA 2001 type of injector which is auto gas approved; and an Arduino type of circuit board, having an AI J1939 protocol translator and the software of the instant invention for propane/diesel flow regulation.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or will be able to ascertain, using no more than routine experimentation, many equivalents to the specific embodiments of the disclosure described herein. It is, therefore, to be understood that the foregoing embodiments are presented by way of example only and that, within the scope of the appended claims and equivalents thereto; the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

As one skilled in the art would recognize as necessary or best-suited for performance of the methods of the invention, a computer system or machines of the invention include one or more processors (e.g., a central processing unit (CPU) a graphics processing unit (GPU) or both), a main memory and a static memory, which communicate with each other via a bus.

A processor may be provided by one or more processors including, for example, one or more of a single core or multi-core processor (e.g., AMD Phenom II X2, Intel Core Duo, AMD Phenom II X4, Intel Core i5, Intel Core I & Extreme Edition 980X, or Intel Xeon E7-2820).

An I/O mechanism may include a video display unit (e.g., a liquid crystal display (LCD) or a cathode ray tube (CRT)), an alphanumeric input device (e.g., a keyboard), a cursor control device (e.g., a mouse), a disk drive unit, a signal generation device (e.g., a speaker), an accelerometer, a microphone, a cellular radio frequency antenna, and a network interface device (e.g., a network interface card (NIC), Wi-Fi card, cellular modem, data jack, Ethernet port, modem jack, HDMI port, mini-HDMI port, USB port), touchscreen (e.g., CRT, LCD, LED, AMOLED, Super AMOLED), pointing device, trackpad, light (e.g., LED), light/image projection device, or a combination thereof.

Memory according to the invention refers to a non-transitory memory which is provided by one or more tangible devices which preferably include one or more machine-readable medium on which is stored one or more sets of instructions (e.g., software) embodying any one or more of the methodologies or functions described herein. The software may also reside, completely or at least partially, within the main memory, processor, or both during execution thereof by a computer within system, the main memory and the processor also constituting machine-readable media. The software may further be transmitted or received over a network via the network interface device.

While the machine-readable medium can in an exemplary embodiment be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. Memory may be, for example, one or more of a hard disk drive, solid-state drive (SSD), an optical disc, flash memory, zip disk, tape drive, “cloud” storage location, or a combination thereof. In certain embodiments, a device of the invention includes a tangible, non-transitory computer readable medium for memory. Exemplary devices for use as memory include semiconductor memory devices, (e.g., EPROM, EEPROM, solid-state drive (SSD), and flash memory devices e.g., SD, micro SD, SDXC, SDIO, SDHC cards); magnetic disks, (e.g., internal hard disks or removable disks); and optical disks (e.g., CD and DVD disks).

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. A system for propane injection modified in real-time by an AI engine controller driving fuel efficiency, whereby data harvested, arrayed, and registered for more than one unit is agglomerated and shared resulting in a net saving over a diesel only system.

2. The system of claim 1, driving propane flow via AI monitoring and algorithmic enhancement, further comprising:
said controller being effective to deliver propane through a vapor injector at precise rates and under specific engine parameters.

3. The system of claim 2, using optimized AI gated propane flow digitized across multiple data points further comprising ranges of propane flow and corrections to the same coordinated wirelessly and integrated with a central interface.

4. The system of claim 3, which comprises:
truck and fleet modules further comprising stand-alone chip integrated solutions having any smart-vehicle, chip-set and remote hardware assembly so required.

5. The system of claim 4, further comprising:
data sets plotting fuel efficiency at various cruise speeds for trucking applications ranging from at least about 7 to 18 percent efficiency of gains over traditional values with diesel alone, as demonstrated by full throttle acceleration testing data interpreted over time.

6. The system of claim 3, further comprising:
diesel engine applications in construction equipment, agricultural engines and generators, whereby load, vibration, terrain & portability issues are already managed and approved or packaged for same for regulatory authorities.

7. The system of claim 5, which further comprises:
an improved software, or specialized computing-means comprising:
ingress and outgress of data allowing AI gated delivery of propane through a vapor injector under predetermined engine cruise conditions further comprising steady state and hard acceleration whereby all other needed driving modes are articulated, including emissions and particulate levels and in-town driving.

8. The system of claim 7, wherein improved hardware, including specialized chip-sets, mask works and personal digital devices embodying the disclosures of the instant teachings are provided.

9. The system of claim 8, further comprising:
emissions testing driving regeneration processing, and related greenhouse gas optimizing schemes.

10. The system of claim 9 effective for tracking said emissions, data linkages, and interfaces, including applications mimicking the Cummings Diesel ® brand of portal and the like-means for tracking, facultatively employed in conjunction with the instant systems for manifesting output.

11. The system of claim 10, further comprising:
Artificial Intelligence optimizing propane flow rates for use with diesel trucks, fleets, controllers, personal data assistants and currency, wherein the steps of managing engine fuel and fuel combinations is electronically implemented and digitally controlled within a plurality of centrally controlled units operating in tandem via the data enriched environment driving fuel mixing protocols and directions.

12. The system of claim 11, further comprising:
proprietary machine-readable media, operatively linked to a plurality of personal digital members (PDMs), arrayed within a fleet of trucks, adjusting in real time the flow of propane into diesel-burning engines said PDMs being any medium that is capable of storing, encoding or carrying a set of instructions for execution by the machine and that cause the machine to perform any one or more of the methodologies of the present invention.

13. A system for injecting propane into the airside of the diesel combustion mix, which comprises:
at least a plurality of personal digital members in active communication with a centralized controller including at least a hub for data;
said hub for data likewise in communication with at least two sub-data aggregation structures, said structures linked to a central controller; fleet data and a stand-alone data structure sending data through an AI propane gate, to and from each of said personal digital members.

14. The system of claim 13, whereby the personal digital members enabling optimization of propane flow, within diesel burning systems; whereby multiple data points and a range of propane flow approaches efficiency gains of at least about 6% over known systems.

15. The system of claim 14, further comprising, in combination, a plurality of fungible personal digital members enabling optimization of propane flow, within diesel burning systems;
whereby multiple data points and a range of propane flow approaches efficiency gains of at least about greater than 7% over known systems.

16. A process for retrofitting diesel systems to manage conversion to more efficient systems, comprising, in combination:
providing a set of systems to be re-configured in terms of efficiency and emissions;
addressing the inflow of propane, via data gathered from individuated units;
gating the engine management system communications network with a centralized Artificial Intelligence Data structure set;
said AI Data structure set further comprises:
at least a central controller filtering a set of HUB for Data inputs;
aggregated from sub-data aggregation units, and recombined—for efficiency driven propane flow scenarios, particulates, and other interim data sets,
whereby said machine learning actuates at least a portion of the paradigm's propane gate.

17. The process of claim 16, useful for truck fleets, further comprising, in combination:
a tank, being PPI 48 or 20 gallon aluminum certified for auto gas use with a cut-off solenoid;
a UL approved line filter to eliminate air bubbles in line;
a Beam Garrettson brand of vaporizing regulator which is auto gas approved;
a HANA 2001 type of injector which is auto gas approved; and
an Arduino type of circuit board, having an AI J1939 protocol translator and the software of the instant invention for propane/diesel flow regulation.

18. The system of claim 5, further comprising, in combination:
Achievement of a propane mpg of at least about 50 mpg.

19. The system of claim 18, whereby a subject tracking vehicle carrying 50 gallons of propane can travel between 2200 and 3300 miles between refueling stops.
